(19) United States
(12) Patent Application Publication
(10) Pub. No.: US 2007/0226727 A1
(43) Pub. Date: Sep. 27, 2007

(54) Method and Apparatus for Updating Firmware

(76) Inventor: Yuh-Long Yeh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/308,075

(22) Filed: Mar. 6, 2006

(51) Int. Cl. G06F 9/44

(52) U.S. Cl. 717/168

(57) ABSTRACT

A device having updatable firmware code includes a non-volatile memory for storing the firmware code; a clock enable controller for generating a clock signal according to a clock source signal when a clock disable signal is unasserted, and further for pausing the clock signal when the clock disable signal is asserted; a micro-controller coupled to the non-volatile memory for performing device operations according to the firmware code and the clock signal, and further for asserting a trigger signal to initiate an update process of the firmware code; and an update controller coupled to the micro-controller, the clock enable controller, and the non-volatile memory for asserting the clock disable signal and then updating the firmware code upon assertion of the trigger signal.

### BACKGROUND

This invention relates to devices containing a micro-controller, and more particularly, to a method and apparatus for updating firmware of a micro-controller.

In our modern high-tech world, computers and electronic devices of various types are vastly abundant. At the core of many of these devices is a micro-controller that acts as the “brain” of the device. Micro-controllers operate on a machine code, or firmware, in order to properly perform device operations. The firmware therefore is basically an electronic instruction set for the micro-controller in order to function and achieve its design goals. For instance, the firmware of a basic digital watch would be simply implemented to keep track of time and handle user features such as alarms and sounds. The firmware of a cellular phone would be more complicated, and would incorporate features for a user interface, cellular transmission and reception protocols, voice processing algorithms, and possibly much more.

For complex electronic devices, updating of firmware may be periodically required. The firmware may not only contain the instruction set for normal device operation, but may also contain user settings and internally defined peripheral data. Therefore, the updating of firmware can act to update certain features, change device configurations, and fix previous errors or “bugs” in the machine code. Firmware is typically stored into and read from a non-volatile memory of the electronic device. Non-volatile memory allows the stored firmware to be retained during device resets power-off. Use of this type of memory is therefore preferred as it manages to retain critical firmware data and settings during power-off, however, it is typically much more expensive than volatile memory. Most devices therefore typically use a non-volatile memory to store firmware, while using a volatile memory for other peripheral processes.

FIG. 1 shows a micro-controller configuration 100 according to the related art used to update firmware. The typical configuration 100 for updating micro-controller firmware includes the micro-controller 110, a volatile memory 120, a non-volatile memory 130, a flash update controller 140, and a multiplexor 150. Firmware is typically read from the non-volatile memory 130, through the multiplexer 150. The update_enable signal is initially selected to allow the contents of the non-volatile memory 130 to pass to the micro-controller 110. Storage for peripheral micro-controller 110 processes occur in the volatile memory 120. The Data_in and Data_out signals represent the respective input and output data paths for the data flow accessing the non-volatile memory 130.

The process of updating firmware when using the configuration of FIG. 1 is described through the flow chart of FIG. 2. When firmware updating is required (step 210), the data path of the volatile memory 120 is stopped (step 220) by asserting a data_path_stop signal so that no other processes can access its memory. The firmware code in the non-volatile memory 130 is then read by the micro-controller 110, and copied into the volatile memory 120 (step 230). The firmware fetching source is then changed from the non-volatile memory 130 to the volatile memory 120 (step 240) by changing the update_enable signal of the mulitplexor 150 to select the volatile memory 120. The microcontroller 110 then asserts the control signal to the flash update controller 140. Upon reception of the control signal, the flash update controller 140 executes the updating of the firmware to the non-volatile memory 130 (step 250) while the micro-controller 110 resumes processing. Once the update is completed, the micro-controller changes the firmware fetching source back to the non-volatile memory 130 (step 260) and resumes data flow to the volatile memory 120.

Although the process described in FIG. 2 does manage to update the firmware code, it is not without its disadvantages. First, this method requires providing a volatile memory 120, and further demands exclusive access to it during the update process. The data path to the volatile memory 120 is stopped during the update process to prevent other processes from accessing it and potentially tampering the firmware code run by the microcontroller 110 during the update process. This results in a reduced system performance should another device component require use of the volatile memory 120 during the update process.

Also according to the prior art, the existing firmware is copied from the non-volatile memory 130 to the volatile memory 120, and run from the volatile memory 120 during the update process. Therefore, a set portion of the volatile memory 120 must be allocated specifically for storing the firmware during the update process. This prohibits other processes of the micro-controller 110 from utilizing the full amount of the volatile memory 120, and thereby effectively reduces its accessible memory. The copying of firmware code from one memory to another is also a time consuming and tedious process that requires several machine steps or cycles by the microprocessor. Increased process and machine steps provide an undue amount of difficulty, and can provide a higher potential for a system crash or failure.

In addition, some processes require the storage of user specific data into the non-volatile memory 130. However, during the update process, the non-volatile memory 130 cannot be accessed by the microcontroller. This may potentially result in processing errors, reduced system performance, and even a possible system halt.

### SUMMARY OF THE INVENTION

One objective of the claimed invention is therefore to provide a device having updatable firmware code, to solve the above-mentioned problem by pausing a clock signal of a micro-controller during an update process of the firmware code.

According to an exemplary embodiment of the claimed invention, a device having updatable firmware code is disclosed. The device comprises a non-volatile memory for storing the firmware code, a clock enable controller for generating a clock signal according to a clock source signal when a clock disable signal is unasserted and further for pausing the clock signal when the clock disable signal is asserted, a micro-controller coupled to the non-volatile memory for performing device operations according to the firmware code and the clock signal and further for asserting a trigger signal to initiate an update process of the firmware code, and an update controller coupled to the micro-controller, the clock enable controller, and the non-volatile memory for asserting the clock disable signal and then updating the firmware code upon assertion of the trigger signal.

According to another exemplary embodiment of the claimed invention, a method for updating firmware code is disclosed. The method comprises providing a non-volatile memory for storing the firmware code, generating a clock signal according to a clock source signal when a clock disable signal is unasserted, pausing the clock signal when the clock disable signal is asserted, providing a micro-controller for performing device operations according to the firmware code and the clock signal, asserting a trigger signal utilizing the micro-controller to initiate an update process of the firmware code, asserting a clock disable signal utilizing an update controller to pause the clock signal and thereby pause device operations of the micro-controller upon assertion of the trigger signal, and updating the firmware code after asserting the clock disable signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a micro-controller configuration of the related art used to update firmware.

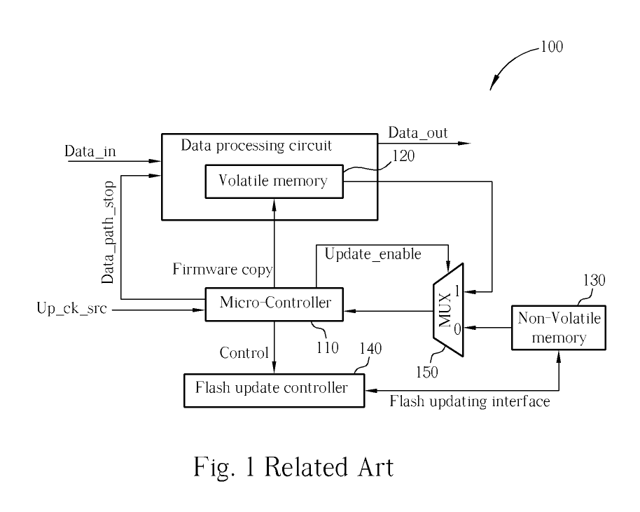

FIG. 2 illustrates a flow chart for the firmware update process using the apparatus of FIG. 1.

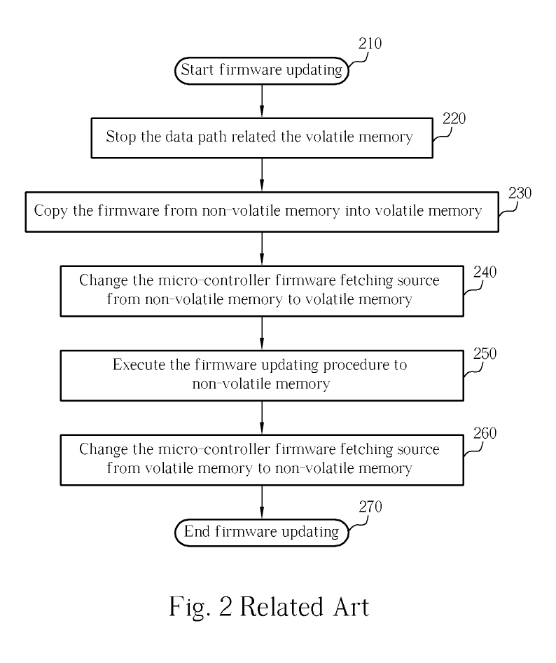

FIG. 3 illustrates an apparatus for updating firmware according to an embodiment of the present invention.

FIG. 4 illustrates a timing diagram for a micro-controller.

FIG. 5 illustrates a flow chart describing the method used for updating firmware according to an embodiment of the present invention.

### DETAILED DESCRIPTION

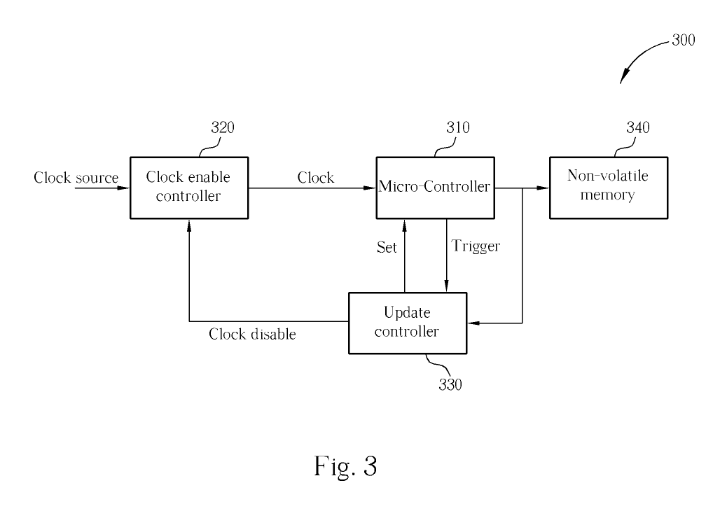

In order to solve the above mentioned problems, a device and apparatus for updating firmware is disclosed according the present invention. FIG. 3 shows an apparatus for updating firmware 300 according to an exemplary embodiment of the present invention. The apparatus 300 includes a micro-controller 310, a clock enable controller 320, an update controller 330, and a non-volatile memory 340. A basic overview of each individual component and its operation is briefly described below.

The micro-controller 310 is coupled to the non-volatile memory 340, and performs device operations according to firmware code located within the non-volatile memory 340. The micro-controller 310 only performs device operations when a clock signal is generated, otherwise its operations are paused. The clock enable controller 320 receives a clock source signal, and generates a clock signal to the micro-controller 310 when the clock disable signal is unasserted. Upon assertion of the clock disable signal, the clock enable controller 320 pauses the clock signal to thereby pause the operations of the micro-controller 310. An update controller 330 is coupled to the micro-controller 310, the clock enable controller 320 and the non-volatile memory 340. The update controller 330 acts to assert a clock disable signal and then update the firmware code in the non-volatile memory 340 upon assertion of a trigger signal by the micro-controller 310.

A detailed description of the complete process for updating firmware using the apparatus 300 is described in the following. Prior to start of the firmware update procedure through assertion of the trigger signal, the micro-controller 310 sends updated firmware code to the update controller 330 through the set signal line. This is because during the firmware update procedure, micro-controller operations become paused, and the update controller 330 acts to update the firmware in the non-volatile memory 340 with the updated firmware code. Therefore, the update controller 330 must possess the updated firmware code prior to assertion of the trigger signal that initiates the start of the firmware update procedure.

After the micro-controller 310 receives a request for firmware updating and has sent the updated firmware code to the update controller 330, the micro-controller 310 begins the process by notifying the update controller 330 through assertion of the trigger signal. The update controller 330 receives the trigger signal from the micro-controller 310, and thereafter asserts a clock disable signal to the clock enable controller 320. As described, the clock enable controller 320 acts to pass a clock signal to the microcontroller 310 contingent on the clock disable signal. In the absence of a clock disable signal, a clock signal is passed to the micro-controller 310. When a clock disable signal is asserted, a clock signal is not sent to the micro-controller 310, hence pausing the operation of the micro-controller 310. Therefore, once a trigger signal is asserted by the micro-controller 310, the micro-controller 310 operations become paused afterwards through the stopping of its clock signal.

While the micro-controller 310 is paused, the update controller 330 acts to update the firmware code in the non-volatile memory 340. The update controller 330 is coupled to the non-volatile memory 340 through a data bus, and updates the firmware in the non-volatile memory 340 according to updated firmware code previously provided by the micro-controller 310 through the set signal line. Upon completion of the update process of firmware code in the non-volatile memory 340, the update controller 330 unasserts the clock disable signal. This allows the clock enable controller 320 to again provide the clock signal to the micro-controller 310. In this way, the micro-controller 310 again receives the clock signal and resumes normal device operations, running under the updated firmware code within the non-volatile memory 340.

To prevent an abrupt stoppage of micro-controller operations during intermediate machine steps, in one exemplary embodiment, the pausing of the clock signal is performed at an endpoint of a complete command cycle of the micro-controller 310. This prevents any timing and processing errors once the micro-controller 310 resumes operations upon restoration of the clock signal. For instance, if a certain command takes four machine steps to complete and the update process of firmware code is initiated during the second machine step, the pausing of the clock signal should be delayed until the fourth step has finished and the current command has completed.

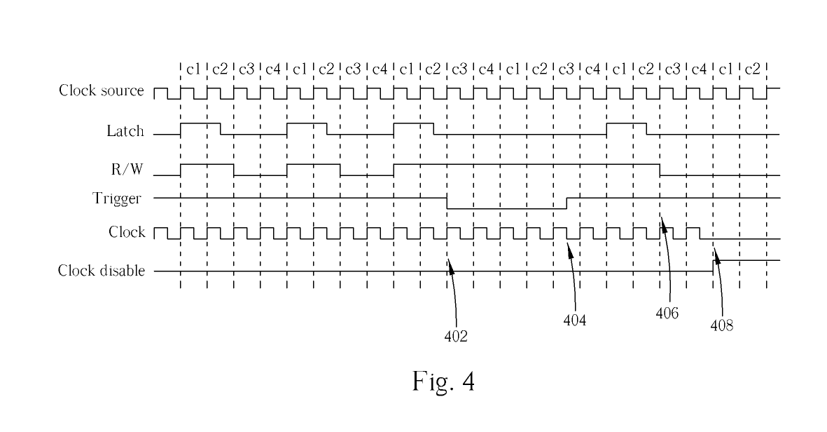

FIG. 4 shows a timing diagram for the micro-controller 310 of this embodiment of present invention to further detail this requirement. In this embodiment, an instruction command is performed and completed within four clock cycles (hence four machine steps). A read/write signal denoted by “R/W” begins to be asserted from cycles c1 to c2. This read/write signal is asserted until the next clock cycle following the falling edge of the address latch signal “latch”, which occurs during c2. At time 402, the trigger signal is asserted during the c2 cycle before the read/write signal becomes latched. The trigger signal normally induces a pausing of the clock signal, however, because the micro-controller 310 is still in progress with the current command, it will not pause the clock signal until completion of the read/write signal through latching. When the trigger signal has been released at 404, the clock enable controller 320 begins to locate an appropriate time to pause the clock signal. The read/write signal is held through until the next c2 cycle, when it can finally be latched at time 406. After this the read/write signal has been latched, the machine step is completed and the clock enable controller 320 can finally pause the clock signal at the end of the fourth clock cycle 408. Now when the micro-controller 310 resumes operation, it will resume at the beginning of a c1 cycle 408, and be prepared to accept the machine step of the next instruction command.

Many implementations can be utilized to assure that the clock signal is paused at an endpoint of a complete command cycle of the micro-controller 310 according to different embodiments of the present invention. For example, in one embodiment (not shown), the clock enable controller 320 is implemented to pause the clock signal at an endpoint of a complete command cycle. Also, in another embodiment, the micro-controller is implemented to assert the trigger signal at an endpoint of a complete command cycle. In yet another embodiment, the update controller 330 asserts the clock disable signal according to a clock disable check unit detecting an endpoint of a complete command cycle of the micro-controller 310. Each of these implementations achieves the same goal of pausing the clock signal at an appropriate time being the endpoint of a complete command cycle of the micro-controller, and as such, any other implementation that achieves this same goal is also included in this teaching.

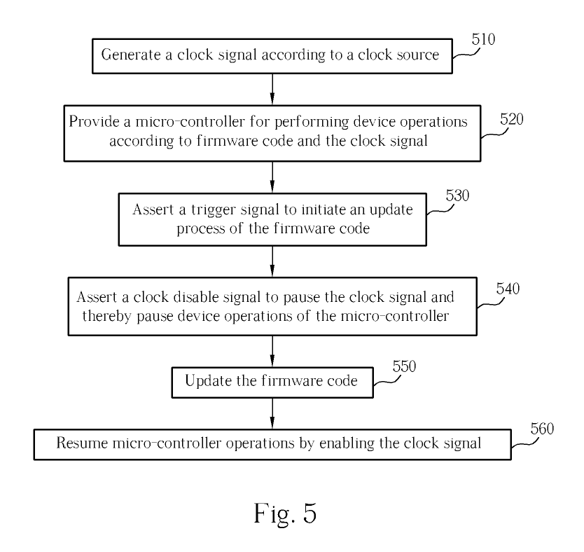

FIG. 5 shows a flow chart describing a method used for updating firmware 500 according to an exemplary embodiment of the present invention as described above. Provided that substantially the same result is achieved, the steps for the method of updating firmware shown in FIG. 5 need not be in the exact order shown and need not be contiguous, that is, other steps can be intermediate. In this embodiment, updating firmware 500 is performed through the following sequence of process steps:

| | |
|---|---|
| Step 510: | Generate a clock signal according to a clock source. |
| Step 520: | Provide a micro-controller for performing device operations |
| | according to firmware code and the clock signal. |
| Step 530: | Assert a trigger signal to initiate an update process of the |
| | firmware code. |
| Step 540: | Assert a clock disable signal to pause the clock signal and |
| | thereby pause device operations of the micro-controller. |
| Step 550: | Update the firmware code. |
| Step 560: | Resume micro-controller operations by enabling the clock |
| | signal. |

As presented, the firmware updating apparatus 300 provides a seamless and simple process flow for the updating of firmware compared to prior art devices. This invention does not require the presence of a volatile memory, since firmware code is not copied over from non-volatile memory. Therefore, alternative device components can still access a volatile memory (if applicable) during the firmware update process of the present invention. The data path to the volatile memory does not need to be stopped, and the firmware fetching source does not need to be changed because the volatile memory is not considered or relied upon in the present invention. This also allows the full capacity of a volatile memory to be utilized for alternative processes, as a prescribed amount does not need to be allocated for the firmware update procedure according to the present invention.

The pausing of the micro-controller during the firmware update procedure also provides many advantages over the prior art. In the prior art, the micro-controller continues operation during the firmware update process. If the micro-controller were to halt or crash during this period, then the firmware update procedure will not conclude, as its functional operation is still required to complete the update process. The micro-controller also cannot access the non-volatile memory during the update procedure because the update controller has exclusive use of it during the updating process. Furthermore, processes run by the micro-controller during the firmware update procedure will not be conducted according to the latest firmware, as it will use the previous version of firmware run on the volatile memory while the firmware on the non-volatile memory becomes updated.

In the present invention, the pausing of the micro-controller allows the update controller to complete the firmware update process before micro-controller actions are resumed. This prevents the possibility of halting or crashing of the micro-controller during the update process. Also, the micro-controller will not need to access the non-volatile memory during the firmware update process because its operations will be temporarily paused. This will result in fewer processing errors when compared to the same situation of the prior art. When the firmware update procedure has completed, the micro-controller can then resume operations under the latest version of firmware. Furthermore, the present invention provides a firmware update procedure with reduced method steps and a simpler process flow. This makes for an overall more efficient update sequence and reduces micro-controller processes to thereby reduce potential system errors and crashing during the firmware update procedure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A device having updatable firmware code, the device comprising:
a non-volatile memory for storing the firmware code;
a clock enable controller for generating a clock signal according to a clock source signal when a clock disable signal is unasserted, and further for pausing the clock signal when the clock disable signal is asserted;
a micro-controller coupled to the non-volatile memory for performing device operations according to the firmware code and the clock signal, and further for asserting a trigger signal to initiate an update process of the firmware code; and
an update controller coupled to the micro-controller, the clock enable controller, and the non-volatile memory for asserting the clock disable signal and then updating the firmware code upon assertion of the trigger signal.

2. The device of claim 1 wherein the micro-controller is further for providing updated firmware code to the update controller prior to asserting the trigger signal, and the update controller is further for updating the firmware code according to the updated firmware code after asserting the clock disable signal.

3. The device of claim 1 wherein the update controller is further for unasserting the clock disable signal upon completion of the update process of the firmware code.

4. The device of claim 1 wherein the clock enable controller is further for pausing the clock signal at an endpoint of a complete command cycle of the micro-controller when the clock disable signal is asserted.

5. The device of claim 1 wherein the micro-controller is further for asserting the trigger signal at an endpoint of a complete command cycle of the micro-controller to initiate the update process of the firmware code.

6. The device of claim 1 wherein the update controller is further for detecting an endpoint of a complete command cycle of the micro-controller, and asserting the clock disable signal at the endpoint of the complete command cycle upon assertion of the trigger signal.

7. A method for updating firmware code, the method comprising:
providing a non-volatile memory for storing the firmware code;
generating a clock signal according to a clock source signal when a clock disable signal is unasserted;
pausing the clock signal when the clock disable signal is asserted;
providing a micro-controller for performing device operations according to the firmware code and the clock signal;
asserting a trigger signal utilizing the micro-controller to initiate an update process of the firmware code;
asserting a clock disable signal utilizing an update controller to pause the clock signal and thereby pause device operations of the micro-controller upon assertion of the trigger signal; and
updating the firmware code after asserting the clock disable signal.

8. The method of claim 7 further comprising providing updated firmware code to the update controller prior to assertion of the trigger signal utilizing the micro-controller, and updating the firmware code according to the updated firmware code after asserting the clock disable signal.

9. The method of claim 7 further comprising unasserting the clock disable signal upon completion of the update process of the firmware code to thereby resume device operations of the micro-controller.

10. The method of claim 7 further comprising pausing the clock signal at an endpoint of a complete command cycle of the micro-controller after the clock disable signal is asserted.

11. The method of claim 7 further comprising asserting the trigger signal at an endpoint of a complete command cycle of the micro-controller to initiate the update process of the firmware code.

12. The method of claim 7 further comprising asserting the clock disable signal at an endpoint of a complete command cycle of the micro-controller upon assertion of the trigger signal.
